(19) United States
(12) Patent Application Publication
(10) Pub. No.: US 2021/0067318 A1
(43) Pub. Date: Mar. 4, 2021

(54) SECURE AUTHENTICATION USING BLOCKCHAIN

(71) Applicant: NEC Laboratories Europe GmbH, Heidelberg (DE)

(72) Inventors: Ghassan Karame, Heidelberg (DE); Claudio Soriente, Madrid (ES)

(21) Appl. No.: 16/690,155

(22) Filed: Nov. 21, 2019

Related U.S. Application Data
(60) Provisional application No. 62/894,878, filed on Sep. 2, 2019.

(51) Int. Cl. H04L 9/06; H04L 9/32; H04L 9/08

(52) U.S. Cl. CPC H04L 9/0637; H04L 9/0869; H04L 9/3218; H04L 9/3271

(57) ABSTRACT

A method for secure user authentication using a blockchain includes computing a cryptographic puzzle and a solution to the cryptographic puzzle. The solution is sent to a user to be authenticated and the cryptographic puzzle is sent to the blockchain. Thereby, the user is authenticatable by a relaying party having read access to the blockchain to fetch the cryptographic puzzle from the blockchain and determine whether the solution as presented to the relaying party by the user is a valid solution to the cryptographic puzzle.

### CROSS-REFERENCE TO PRIOR APPLICATION

Priority is claimed to U.S. Provisional Application No. 62/894,878 filed on Sep. 9, 2019, the entire contents of which is hereby incorporated by reference herein.

### FIELD

The present invention relates to authentication methods and systems using distributed ledger technology, and in particular to blockchains and blockchain networks.

### BACKGROUND

User authentication, be it based on passwords, one-time codes or digital signatures, is currently carried out by a stand-alone Identity Provider (IdP). In order to reduce management costs many application providers (also called Relaying Parties or RP) resort to federated authentication by outsourcing user authentication to a third-party IdP.

### SUMMARY

In an embodiment, the present invention provides a method for secure user authentication using a blockchain. The method includes computing a cryptographic puzzle and a solution to the cryptographic puzzle. The solution is sent to a user to be authenticated and the cryptographic puzzle is sent to the blockchain. Thereby, the user is authenticatable by a relaying party having read access to the blockchain to fetch the cryptographic puzzle from the blockchain and determine whether the solution as presented to the relaying party by the user is a valid solution to the cryptographic puzzle.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the present invention. The features and advantages of various embodiments of the present invention will become apparent by reading the following detailed description with reference to the attached drawings which illustrate the following:

FIG. 1 schematically illustrates a system and method according to embodiments of the present invention; and

FIG. 2 schematically illustrates a system and method according to an embodiment of the present invention in which a distributed IdP is implemented in a blockchain network.

### DETAILED DESCRIPTION

Embodiments of the present invention enhance and improve authentication systems with distributed ledger technology. Using distributed ledger technology, the task of authenticating a user can be distributed so as to avoid single points of failure, thereby also enhancing security and data privacy. Further, using distributed ledger technology improves authentication by enabling seamless federated authentication and minimizing the interaction between IdPs and RPs. In contrast to single sign-on solutions, users are not locked to specific IdPs, which may act maliciously. Additionally, the need to otherwise provide for secure communication channels can be avoided along with the associated computational resources and computing power, thereby improving the authentication network itself.

It has been recognized in accordance with an embodiment of the present invention that the IdP can represent a single point of failure. For example, the IdP may arbitrarily accept or reject an authentication request, or it can tamper with the authentication history of a user. Further, federated authentication requires complex agreements and setup between the RP and the IdP. As a result, RPs only use few IdPs, and in many cases only a single IdP. Thus, either a user has an account with the IdP used by the RP, or else the user will not be able to use the service offered by the RP.

Embodiments of the present invention solve the above problems and enhance user authentication with a distributed ledger. The ledger may be used to distribute the authentication across multiple nodes and to obtain a tamper-free log of the authentication attempts and their outcomes. The ledger may be also used to minimize the interaction between IdPs and RPs in federated logins.

An embodiment of the present invention provides for a practical application of the Schnorr identification scheme for authentication using distributed ledger technology, and in particular a blockchain network which relies on consensus among the nodes of the network. The Schnorr identification scheme allows a prover P to prove in zero-knowledge to a verifier V knowledge of the discrete logarithm of an element in a cyclic group of prime order. It works as follows: G represents a cyclic group of prime order p where the computational discrete logarithm assumption holds; g is a public generator of G; y=g^{x} mod p where x is only known to P; Zₚ is a multiplicative group of integers that are co-prime with p; and r, c and s are elements of Zₚ (an integer co-prime with p). The Schnorr identification scheme then works as follows:

1. P picks r∈Zₚ uniformly at random and sends t=g^{r} mod p to V
2. V picks c∈Zₚ uniformly at random and sends it to P
3. P computes s=r+cx mod p and sends it to V
4. V accepts the proof as valid if g^{s}=t·y^{c}

Accordingly, if the P supplies the correct value for s such that g^{s}=t·y^{c} holds, V can authenticate that P has the correct value for x.

In one embodiment, the distributed ledger can be used to remove the burden of setting up agreements or direct communication channels between IdPs and RPs in federated login. In federated login protocols like OAuth, the IdP provides authenticated users with bearer tokens that are to be presented to the RP in order for the RP to validate the user identity. Bearer tokens include user information and a random value that is sufficiently long (e.g., 256 bits) to make it hard to guess. Token validation by the RP can be carried out in two ways. One option is to have a direct communication link between the RP and the IdP so that RP receives from the IdP the random value that is included in the token given to the user. In this case, the RP checks whether the random value received by the IdP matches the one in the bearer token presented by the user. If the two random values match, the RP validates the identity of the user. Another option is for the IdP to instantiate a digital signature scheme and provide the RP with the verification key. In this case, the IdP signs the bearer tokens sent to authenticated users. The RP verifies the signature on the bearer token presented by the user. If the signature is valid, the RP validates the user identity. Both cases require an agreement and setup procedure between the IdP and the RP in order to establish a direct communication channel or to share the details of the digital signature scheme used by the IdP and the corresponding verification key.

In the current embodiment, IdPs and RPs have access to a permissioned distributed ledger. Upon user authentication, the IdP provides the bearer token including a random value to the authenticated user, and casts the same random value to the distributed ledger. Any RP with access to the ledger can obtain the random value and match it against the one included in the bearer token presented by the user. If the two random values match, the RP validates the identity of the user.

The above embodiment requires the IdP to publish to the ledger random values included in bearer tokens so to make them available to any RP with access to the ledger. Hence, a malicious RP may impersonate a victim user with respect to another RP.

In another embodiment, the IdP casts to the distributed ledger a cryptographic puzzle P, whereas the token sent to an authenticated user includes the solution S to puzzle P. Hence, the user presents the solution S to the RP; the RP obtains the puzzle P from the distributed ledger and if S is a valid solution to P, then the RP validates the user identity. For example, a valid puzzle could be y=H(x) where H is a cryptographic hash function (e.g., SHA256) and x is a random bitstring of sufficient length (e.g., 256 bits); the solution to the puzzle is the pre-image of y (i.e., x). Another example of puzzle is an instance of the discrete logarithm problem. In this embodiment, the puzzle P is a pair of elements y, g of a cyclic group G of prime order for a sufficiently large prime (e.g., 1024 bits), where g is a generator of the group; the solution to the puzzle is x such that g^{x}=y.

In an embodiment, the present invention provides a method for secure user authentication using a blockchain. The method includes computing a cryptographic puzzle and a solution to the cryptographic puzzle. The solution is sent to a user to be authenticated and the cryptographic puzzle is sent to the blockchain. Thereby, the user is authenticatable by a relaying party having read access to the blockchain to fetch the cryptographic puzzle from the blockchain and determine whether the solution as presented to the relaying party by the user is a valid solution to the cryptographic puzzle

In an embodiment, the method includes computing first and second random values and sending the random values to the user.

In an embodiment, the first random value is used as a message identifier for the cryptographic puzzle, and the cryptographic puzzle is computed using the second random value.

In an embodiment, the cryptographic puzzle is sent to the blockchain concatenated together with information about the user in a message identified using the message identifier.

In an embodiment, the cryptographic puzzle is a hash function of the second random value.

In an embodiment, the cryptographic puzzle is an instance of a discrete logarithm problem.

In another embodiment, which can act as a distributed IdP, a method for secure user authentication using a blockchain includes storing in the blockchain a random salt and a cryptographic puzzle which depends on a secret credential of a user, wherein the blockchain is configured to output a second value after receiving a first value from the user. The first value and a third value are fetched from the blockchain, the third value having been computed by the user based on the second value and a solution to the cryptographic puzzle. It is determined whether the third value was computed correctly by the user and a message is sent to the blockchain indicating whether the third value was computed correctly by the user such that the user is authenticatable by a relaying party having read access to the blockchain to fetch the message.

In an embodiment, the authentication uses the Schnorr identification scheme.

In an embodiment:
the first value was computed as t=g^{r} mod p, wherein r was picked as a random r∈Zₚ, wherein g is a public generator of a cyclic group of prime order p and wherein Zₚ is a multiplicative group of integers that are co-prime with p;

the third value was computed as s=r+cH(z, x) mod p, wherein c is the second value which is output by the blockchain as a random c∈Zₚ, wherein z is the random salt and x is the secret credential of the user, and wherein H(z,x) is the solution to the cryptographic puzzle; and

the determining whether the third value was computed correctly by the user includes checking for reaching consensus in the blockchain on whether g^{s}=t·y^{c} and whether the first value was committed to the blockchain before the second value was output by the blockchain.

In an embodiment, the first and third values are stored in the blockchain as tuples which include a username, and the message sent to the blockchain indicating whether the third value was computed correctly by the user is a tuple which includes the username.

In an embodiment, the blockchain is configured to output the second value via a smart contract which specifies to sample a value output by the blockchain after the user has sent the first value to the blockchain.

In further embodiments, an authentication system comprises one or more processors which, alone or in combination, are configured to allow for execution of any of the methods according to embodiments of the present invention.

In even further embodiments, a tangible, non-transitory computer-readable medium comprises instructions which, upon execution on one or more processors cause the one or more processors, alone or in combination, to allow for execution of any of the methods according to embodiments of the present invention.

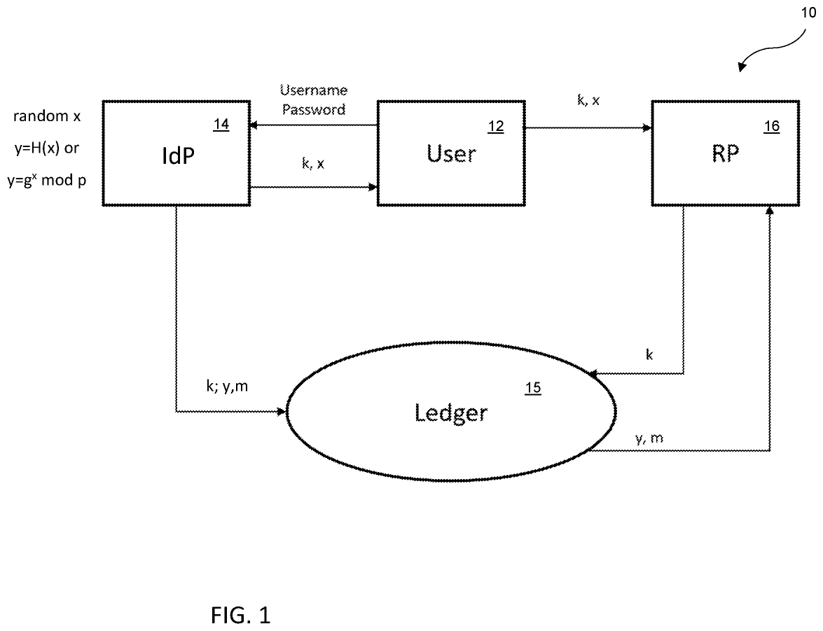

In the following, the steps according to an embodiment of the present invention are detailed for a method when the puzzle is the image of a hash function. Message flows are depicted in FIG. 1, which schematically illustrates an authentication system 10, according to an embodiment of the present invention. A permissioned distributed ledger 15 is provided for which IdPs 14 have read and write access and RPs 16 have read access. Any party having write access to the ledger, can send a message by specifying a (k; v) pair where k is a unique identifier of the message and v represents the message content. Any party having read access to the ledger 15 can fetch a message specifying the message identifier k; if the ledger 15 holds a pair (k; v), then value v is returned. The method includes:

1. User 12 sends an authentication request to identity provider IdP 14. The request may include any identifier of user 12 such as his/her username, and an authenticator, such as password, public key certificate, one-time code, etc.
2. IdP 14 decides with arbitrary logic whether the sender of the authentication request is the user 12. This arbitrary logic depends on the authentication system in place. For example, if authentication is password-based, the logic will check if the password supplied by the user matches the one stored by the IdP 14 for the purported user 12. In case IdP 14 decides that the authentication request did not came from the user 12, it aborts. Otherwise, IdP 14 picks two random values k and x of sufficient length (e.g., 256 bits each), computes a puzzle y as y=H(x) where H is a suitable hash function (e.g., SHA256), and sends message (k; x) to user 12 wherein x represents the solution to the puzzle y. Since the hash function H is one-way, given y it is difficult to find x. So x is given to the user 12 as the solution to y which the user 12 can later use as proof that the solution is known by the user 12. Next, IdP 14 prepares a message m containing relevant information about user the user 12, e.g., his/her username, attributes, timestamp of the authentication request received by the user 12, etc., and writes to the ledger 15 a message (k; y, m) where the comma between y and m denotes message concatenation.
3. User 12 sends message (k; x) to RP 16.
4. RP 16 fetches from the ledger 15 the message with identifier k, let it be z. Next, RP 16 parses z as y, m. In other words, RP 16 is given (k;x) by the user 12. RP 16 then uses k to fetch (k;y,m) from the ledger 15 (i.e., k is used as a pointer). RP 16 then applies H to the x received by the user 12 and checks if the outcome matches they fetched from the ledger 15. If this check succeeds, then RP 16 accepts m as valid data for the user. Finally, RP 16 checks whether H(x) matches y and if this is the case, accepts the information in m as valid data for user 12; otherwise RP 16 aborts.

In the following, the steps of an embodiment of the present invention are detailed for a method when the puzzle is an instance of the discrete logarithm problem. Let G be a cyclic group of prime order p, for a sufficiently large p (e.g., 1024 bits), where the computational discrete logarithm assumption holds. The method includes:

1. User 12 sends an authentication request to identity provider IdP 14. The request may include any identifier of user 12 such as his/her username, and an authenticator, such as password, public key certificate, one-time code, etc.
2. IdP 14 decides with arbitrary logic whether the sender of the authentication request is user 12. In case IdP 14 decides that the authentication request did not came from user 12, it aborts. Otherwise, IdP 14 picks random value k of sufficient length (e.g., 256 bits) and a random value x∈Zₚ. Next, IdP 14 computes y=g^{x} mod p and sends (k; x) to user 12. IdP 14 prepares a message m containing relevant information about user 12, e.g., his/her username, attributes, timestamp of the authentication request received by user 12, etc., and writes to the ledger 15 a message (k; y, m) where the comma between y and m denotes message concatenation.
3. User 12 sends (k; x) to RP 16.
4. RP 16 fetches from the ledger 15 the message with identifier k, let it be z. Next, RP 16 parses z as y, m. Finally, RP 16 checks whether g(=y mod p and, if this is the case, accepts the information in m as valid data for user 12; otherwise it aborts.

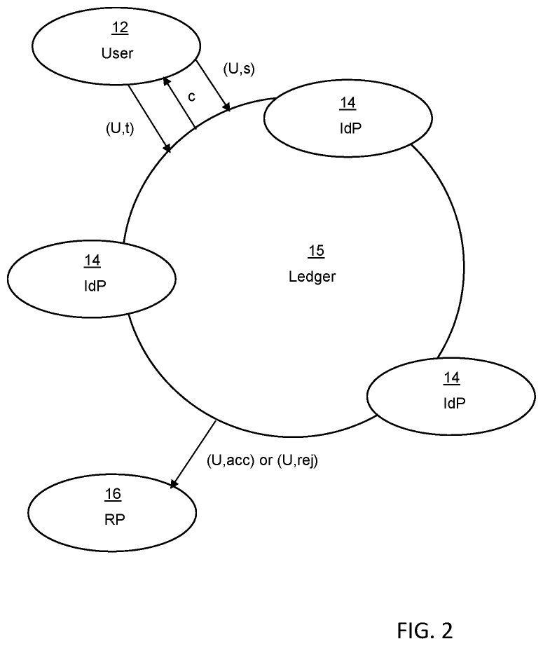

In another embodiment illustrated in FIG. 2, the ledger 15 is used as a distributed IdP 14. In particular, each IdP 14 comprising a node of the ledger 15 stores a copy of the user database including different users 12 where each record is a tuple (U, z, y) where U is a username, z is a random salt of sufficient length (i.e., 256 bits) and a puzzle y as y=g^{H(z,x)} mod p where H is a suitable hash function (e.g., SHA256) and x is the secret credential of user 12, e.g., his/her password. Accordingly, in this embodiment, the solution to puzzle y is H(z,x) where z is chosen by an IdP 14 and x is chosen by the user 12. Authentication is carried out as follows:

1. User 12 picks a random r∈Zₚ, computes t=g^{r} mod p, and casts the tuple (U, t) to the ledger 15. The user 12 therefore has at least write access to the ledger 15.
2. Ledger 15 outputs a random c∈Zₚ. This can be done by sampling headers of the latest blocks in the blockchain. This can be achieved, for example, using a smart contract. The random element c can be sampled from any value output by the blockchain so long as this output happened after the user 12 casting the tuple (U, t) to the ledger 15. The value c can be transmitted to the user 12 after being output by the ledger, for example, by a secure message.
3. User 12 computes s=r+cH(z, x) mod p and casts the tuple (U, s) to the ledger 15. The solution H(z,x) is only known to the user 12. Values t and s allow the user 12 to prove knowledge of the solution to puzzle y without revealing information about the puzzle itself.
4. Each of the IdPs 14 acting as nodes of the ledger 15 fetches tuples (U, t) and (U, s) from the ledger 15 and checks if g^{s}=t·y^{c}. If this equality holds and the tuple (U, t) was committed before c was available, then one of the IdPs 14 acting as a node casts the message (U, acc) to the ledger; otherwise it casts the message (U, rej) to the ledger 15.
5. User 12 is authenticated only if consensus is reached among the nodes in step 4 and the message (U, acc) is committed to the ledger 15. In order to determine this, an RP 16 has at least read access to the ledger 15.

Embodiments of the present invention allow for one or more of the following improvements:

1. Using a distributed ledger 15 as a distributed authentication platform to replace vendor specific authentication schemes by implementing a replicated identity verification scheme based on the Schnorr identification scheme.
2. Using a distributed ledger 15 to enable federated login without the setup burden for IdPs 14 and RPs 16 by casting cryptographic puzzles to the ledger 15 and providing users 12 with the respective solutions so the users 12 can authenticate to RPs 16.
3. Allowing for reliance on multiple IdPs 14 to handle authentication requests in a distributed manner without hampering the security offered by standard approaches.
4. Eliminating single points of failure and increasing security and privacy by preventing IdPs 14 from acting corruptly or maliciously.

According to an embodiment, a method for authenticating a user 12 comprises:

1. Setting up a distributed ledger 15 between an IdP 14 and RP 16.
2. Creating, by the IdP 14, a puzzle y and a solution x to the puzzle y.
3. Sending, by the IdP 14, the solution x to a user 12.
4. Sending, by the IdP 14, the puzzle y to the ledger 15.
5. Authenticating the user 12, by the RP 16, only if the user 12 presents the valid solution x to the puzzle y fetched from the ledger 15.

In each of the embodiments, each of the user 12, IdP 14 and RP 16 are computer entities (e.g., servers, special-purpose computers, smartphones, tablets or computers configured to perform functions specified herein) comprising one or more processors, and the ledger 15 is a blockchain. The processors can include one or more distinct processors, each having one or more cores, and access to memory. Each of the distinct processors can have the same or different structure. The processors can include one or more central processing units (CPUs), one or more graphics processing units (GPUs), circuitry (e.g., application specific integrated circuits (ASICs)), digital signal processors (DSPs), and the like. The processors can be mounted to a common substrate or to multiple different substrates. Processors are configured to perform a certain function, method, or operation (e.g., are configured to provide for performance of a function, method, or operation) at least when one of the one or more of the distinct processors is capable of performing operations embodying the function, method, or operation. Processors can perform operations embodying the function, method, or operation by, for example, executing code (e.g., interpreting scripts) stored on memory and/or trafficking data through one or more ASICs. Processors can be configured to perform, automatically, any and all functions, methods, and operations disclosed herein. Therefore, processors can be configured to implement any of (e.g., all) the protocols, devices, mechanisms, systems, and methods described herein. For example, when the present disclosure states that a method or device performs task “X” (or that task “X” is performed), such a statement should be understood to disclose that processor is configured to perform task “X”.

Each of the computer entities can include memory. Memory can include volatile memory, non-volatile memory, and any other medium capable of storing data. Each of the volatile memory, non-volatile memory, and any other type of memory can include multiple different memory devices, located at multiple distinct locations and each having a different structure. Memory can include remotely hosted (e.g., cloud) storage. Examples of memory include a non-transitory computer-readable media such as RAM, ROM, flash memory, EEPROM, any kind of optical storage disk such as a DVD, magnetic storage, holographic storage, a HDD, a SSD, any medium that can be used to store program code in the form of instructions or data structures, and the like. Any and all of the methods, functions, and operations described in the present application can be fully embodied in the form of tangible and/or non-transitory machine-readable code (e.g., interpretable scripts) saved in memory.

Each of the computer entities can include input-output devices. Input-output devices 906 can include any component for trafficking data such as ports, antennas (i.e., transceivers), printed conductive paths, and the like. Input-output devices can enable wired communication via USB®, DisplayPort®, HDMI®, Ethernet, and the like. Input-output devices 906 can enable electronic, optical, magnetic, and holographic, communication with suitable memory 906. Input-output devices 906 can enable wireless communication via WiFi®, Bluetooth®, cellular (e.g., LTE®, CDMA®, GSM®, WiMax®, NFC®), GPS, and the like. Input-output devices can include wired and/or wireless communication pathways.

While the invention has been illustrated and described in detail in the drawings and foregoing description, such illustration and description are to be considered illustrative or exemplary and not restrictive. It will be understood that changes and modifications may be made by those of ordinary skill within the scope of the present invention. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for secure user authentication using a blockchain, the method comprising:
computing a cryptographic puzzle and a solution to the cryptographic puzzle; and
sending the solution to a user to be authenticated and sending the cryptographic puzzle to the blockchain such that the user is authenticatable by a relaying party having read access to the blockchain to fetch the cryptographic puzzle from the blockchain and determine whether the solution as presented to the relaying party by the user is a valid solution to the cryptographic puzzle.

2. The method according to claim 1, further comprising computing first and second random values and sending the random values to the user.

3. The method according to claim 2, wherein the first random value is used as a message identifier for the cryptographic puzzle, and wherein the cryptographic puzzle is computed using the second random value.

4. The method according to claim 3, wherein the cryptographic puzzle is sent to the blockchain concatenated together with information about the user in a message identified using the message identifier.

5. The method according to claim 3, wherein the cryptographic puzzle is a hash function of the second random value.

6. The method according to claim 1, wherein the cryptographic puzzle is an instance of a discrete logarithm problem.

7. A tangible, non-transitory computer-readable medium comprising instructions which, upon execution on one or more processors cause the one or more processors, alone or in combination, to allow for execution of the method according to claim 1.

8. An authentication system comprising one or more processors which, alone or in combination, are configured to allow for execution of a method comprising:
computing a cryptographic puzzle and a solution to the cryptographic puzzle; and
sending the solution to a user to be authenticated and sending the cryptographic puzzle to the blockchain such that the user is authenticatable by a relaying party having read access to the blockchain to fetch the cryptographic puzzle from the blockchain and determine whether the solution as presented to the relaying party by the user is a valid solution to the cryptographic puzzle.

9. A method for secure user authentication using a blockchain that is adapted to store a random salt and a cryptographic puzzle which depends on a secret credential of a user, the blockchain being configured to output a second value after receiving a first value from the user, the method comprising:
fetching from the blockchain the first value and a third value computed by the user based on the second value and a solution to the cryptographic puzzle; and
determining whether the third value was computed correctly by the user and sending a message to the blockchain indicating whether the third value was computed correctly by the user such that the user is authenticatable by a relaying party having read access to the blockchain to fetch the message.

10. The method according to claim 9, wherein the authentication uses the Schnorr identification scheme.

11. The method according to claim 9, wherein:
the first value was computed as t=g^{r} mod p, wherein r was picked as a random r∈Zₚ, wherein g is a public generator of a cyclic group of prime order p and wherein Zₚ is a multiplicative group of integers that are co-prime with p;
the third value was computed as s=r+cH(z, x) mod p, wherein c is the second value which is output by the blockchain as a random c∈Zₚ, wherein z is the random salt and x is the secret credential of the user, and wherein H(z,x) is the solution to the cryptographic puzzle; and
the determining whether the third value was computed correctly by the user includes checking for reaching consensus in the blockchain on whether g^{s}=t·y^{c} and whether the first value was committed to the blockchain before the second value was output by the blockchain.

12. The method according to claim 11, wherein the first and third values are stored in the blockchain as tuples which include a username, and wherein the message sent to the blockchain indicating whether the third value was computed correctly by the user is a tuple which includes the username.

13. The method according to claim 9, wherein the blockchain is configured to output the second value via a smart contract which specifies to sample a value output by the blockchain after the user has sent the first value to the blockchain.

14. An authentication system comprising one or more processors which, alone or in combination, are configured to allow for execution of the method according to claim 9.

15. A tangible, non-transitory computer-readable medium comprising instructions which, upon execution on one or more processors cause the one or more processors, alone or in combination, to allow for execution of the method according to claim 9.
